(19) United States
(12) Patent Application Publication
(10) Pub. No.: US 2026/0188042 A1
(43) Pub. Date: Jul. 2, 2026

(54) BOARDING ASSISTANCE DEVICE, BOARDING ASSISTANCE METHOD, AND PROGRAM RECORDING MEDIUM

(71) Applicant: NEC Corporation, Minato-ku, Tokyo (JP)

(72) Inventors: Nozomi MATSUMOTO, Tokyo (JP); Yoko TANAKA, Tokyo (JP); Hitomi ITO, Tokyo (JP); Masaru YANAI, Tokyo (JP); SWAKA SEKI, Tokyo (JP); Kosei KOBAYASHI, Tokyo (JP)

(73) Assignee: NEC Corporation, Minato-ku, Tokyo (JP)

(21) Appl. No.: 18/845,996

(22) PCT Filed: Mar. 24, 2022
(86) PCT No.: PCT/JP2022/013967

§ 371 Date: Sep. 11, 2024

(51) Int. Cl. G06V 40/10; G06F 3/14; G06V 20/52; G07C 11/00

(52) U.S. Cl. CPC G06V 40/10; G06F 3/14; G06V 20/52; G07C 11/00

(57) ABSTRACT

This boarding assistance device comprises one or more memories storing instructions; and one or more processors configured to execute the instructions to: recognize a passenger who is waiting to embark in an embarkation area at a joint transportation facility; estimate the destination of the passenger; count the number of passengers for each destination; and cause a prescribed destination display device to display a destination in accordance with the number of passengers for each destination.

### TECHNICAL FIELD

The present invention relates to a boarding assistance device, an onboard terminal, a boarding assistance method, and a program recording medium.

### BACKGROUND ART

Route buses driven on different routes may pass through the same stop, and a passenger needs to distinguish which bus to get on by a destination system symbol displayed on a destination display device (destination sign) set on a front surface or a side surface of the bus. In recent years, there has also been an increase in railway lines where different companies operate on the same route, and in this case, passengers need to be very careful to avoid boarding a wrong train.

PTL 1 discloses a boarding assistance device that enables a user to easily distinguish a route bus reserved by the user. According to PTL 1, the boarding assistance device displays a name of an alighting bus stop on a destination display device set on a front side of a vehicle or a destination display device set on a side of the vehicle when the bus approaches a bus stop where the user who has made a reservation in advance waits. Further, PTL 1 describes that in a case where a plurality of users waiting at a bus stop make different reservations, the boarding assistance device displays a plurality of alighting bus stops on the destination display device (Paragraph 0082).

### CITATION LIST

### Patent Literature

PTL 1: JP 2015-056081 A

### SUMMARY OF INVENTION

### Technical Problem

The boarding assistance device of PTL 1 has a problem that an alighting bus stop is not displayed unless a passenger makes a reservation in advance. In addition, in a case where there are a number of passengers, there is a possibility that all of alighting bus stops of the passengers cannot be displayed on a display device of the destination display device.

An object of the present invention is to provide a boarding assistance device, an onboard terminal, a boarding assistance method, and a program recording medium that enable a passenger to easily distinguish which vehicle or the like to board without making a reservation in advance.

### Solution to Problem

According to a first aspect, there is provided a boarding assistance device including: passenger recognition means for recognizing a passenger waiting to board in a boarding area for public transport; destination estimation means for estimating a destination of the passenger; counting means for counting the number of passengers for each destination; and display control means for causing a predetermined destination display device to perform destination display according to the number of passengers for each destination.

According to a second aspect, there is provided an onboard terminal having a function of receiving a destination display instruction from the boarding assistance device described above and displaying the destination on a display device set on a front surface, a rear surface, or a side surface of a vehicle.

According to a third aspect, there is provided a boarding assistance method including: recognizing a passenger waiting to board in a boarding area for public transport; estimating a destination of the passenger; counting the number of passengers for each destination; and causing a predetermined destination display device to perform destination display according to the number of passengers for each destination.

According to a fourth aspect, there is provided a program recording medium recording a program for causing a computer to execute processing of: recognizing a passenger waiting to board in a boarding area for public transport; estimating a destination of the passenger; counting the number of passengers for each destination; and causing a predetermined destination display device to perform destination display according to the number of passengers for each destination.

### Advantageous Effects of Invention

According to the present invention, the boarding assistance device, the onboard terminal, the boarding assistance method, and the program recording medium that enable a passenger to easily distinguish which vehicle or the like to board without making a reservation in advance.

### BRIEF DESCRIPTION OF DRAWINGS

FIG. 1 is a diagram illustrating a configuration according to an example embodiment of the present invention.

FIG. 2 is a diagram for describing an operation according to an example embodiment of the present invention.

FIG. 3 is a diagram for describing the operation according to an example embodiment of the present invention.

FIG. 4 is a diagram illustrating a configuration according to a first example embodiment of the present invention.

FIG. 5 is a diagram illustrating an example of estimation result information held by a boarding assistance device of the first example embodiment of the present invention.

FIG. 6 is a diagram illustrating a configuration of a vehicle in which the boarding assistance device of the first example embodiment of the present invention performs display control.

FIG. 7 is a flowchart illustrating an operation of the boarding assistance device of the first example embodiment of the present invention.

FIG. 8 is a diagram for describing an operation of the boarding assistance device of the first example embodiment of the present invention.

FIG. 9 is a diagram for describing an operation of the boarding assistance device of the first example embodiment of the present invention.

FIG. 10 is a diagram illustrating a configuration according to a second example embodiment of the present invention.

FIG. 11 is a flowchart illustrating an example of estimation result information held by a boarding assistance device of the second example embodiment of the present invention.

FIG. 12 is a flowchart illustrating an operation of the boarding assistance device of the second example embodiment of the present invention.

FIG. 13 is a diagram for describing the operation of the boarding assistance device of the second example embodiment of the present invention.

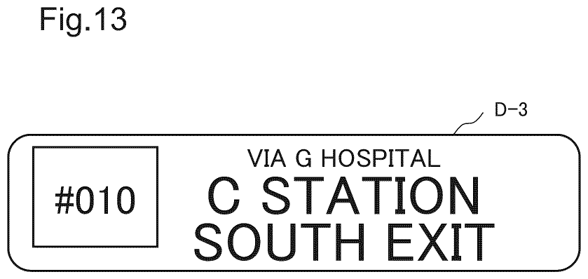

FIG. 14 is a diagram illustrating a configuration of a computer that can function as the boarding assistance device of the present invention.

### EXAMPLE EMBODIMENT

First, an outline of an example embodiment of the present invention will be described with reference to the drawings. Note that reference numerals in the drawings for this outline denote elements for convenience as an example for assisting understanding, and are not intended to limit the present invention to the illustrated aspects. In addition, connection lines between blocks in the drawings and the like referred to in the following description include both bidirectional lines and unidirectional lines. A unidirectional arrow schematically indicates a main flow of a signal (data), and does not exclude bidirectionality. A program is executed via a computer device, and the computer device includes, for example, a processor, a storage device, an input device, a communication interface, and a display device as necessary. In addition, the computer device is configured to be able to communicate with a device (including a computer) inside or outside the device via the communication interface, whether wired or wireless. Ports and interfaces provided at connection points of input and output of each block are omitted in the drawings.

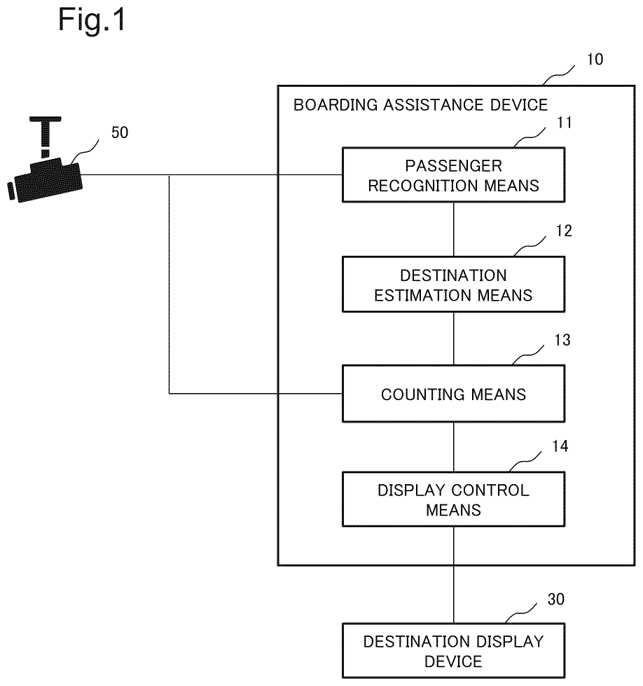

In an example embodiment of the present invention, as illustrated in FIG. 1, the present invention can be implemented by a boarding assistance device 10 including passenger recognition means 11, destination estimation means 12, counting means 13, and display control means 14.

More specifically, the passenger recognition means 11 recognizes a passenger waiting to board in a boarding area for public transport.

The destination estimation means 12 estimates a destination of the passenger. For example, the destination estimation means 12 estimates the destination of the passenger based on an image of the passenger captured by a camera 50.

The counting means 13 counts the number of passengers for each destination.

The display control means 14 causes a predetermined destination display device 30 to perform destination display according to the number of passengers for each destination.

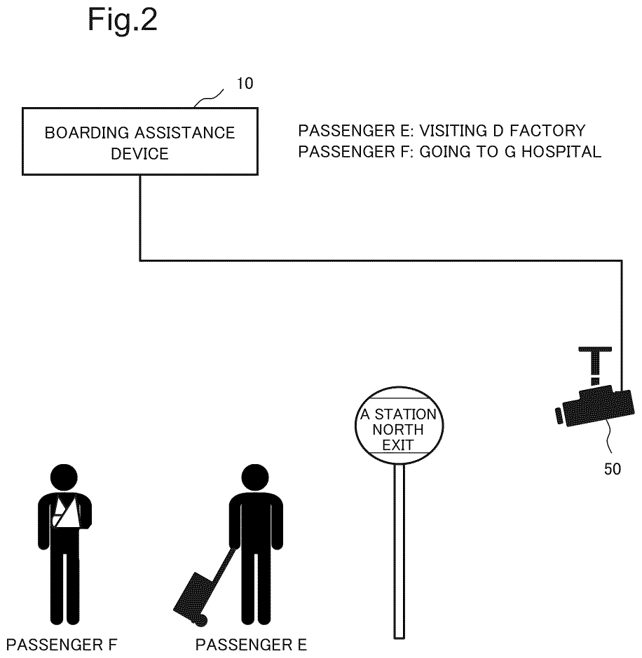

FIG. 2 is a diagram for describing an operation according to an example embodiment of the present invention. In the example of FIG. 2, two passengers E and F are waiting to board at a bus stop (the boarding area for the public transport). The boarding assistance device 10 recognizes each passenger and estimates each destination from the image captured by the camera 50.

For example, the boarding assistance device 10 determines that the passenger E is a business man and determines that the passenger E is heading to a D factory on a route departing from the bus stop. Similarly, the boarding assistance device 10 determines that the passenger F is a patient who is going to a hospital since the passenger F has his/her arm in plaster, and determines that the passenger F is going to a G hospital on the route departing from the bus stop.

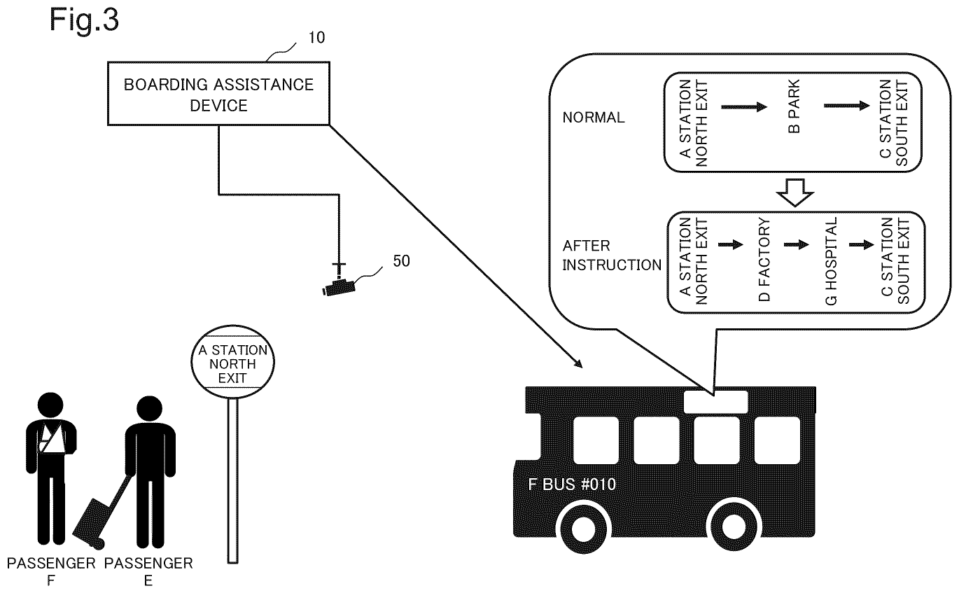

In this case, the boarding assistance device 10 counts one passenger heading to the D factory and one passenger heading to the G hospital. Then, as illustrated in FIG. 3, the boarding assistance device 10 changes display on the destination display device (destination sign) set on a side surface of a bus on which the passengers board. Specifically, the boarding assistance device 10 instructs to change normal route display of A station north exit→B park→C station south exit to route display of A station north exit→D factory→G hospital→C station south exit for the passengers. In addition, there are a large number of destinations to be displayed, and all the destinations may not be simultaneously displayed on the destination display device in a normal display format. In this case, the boarding assistance device 10 may change the display format in such a way as to perform scrolling display or reduce a size of displayed characters.

When the bus arrives, the two passengers E and F refer to the destination display device (destination sign) set on the side surface of the bus. At this time, since the route display of A station north exit→D factory→G hospital→C station south exit is made, the two passengers E and F can confidently board the bus and head to the destinations even if it is their first time visiting the area.

### First Example Embodiment

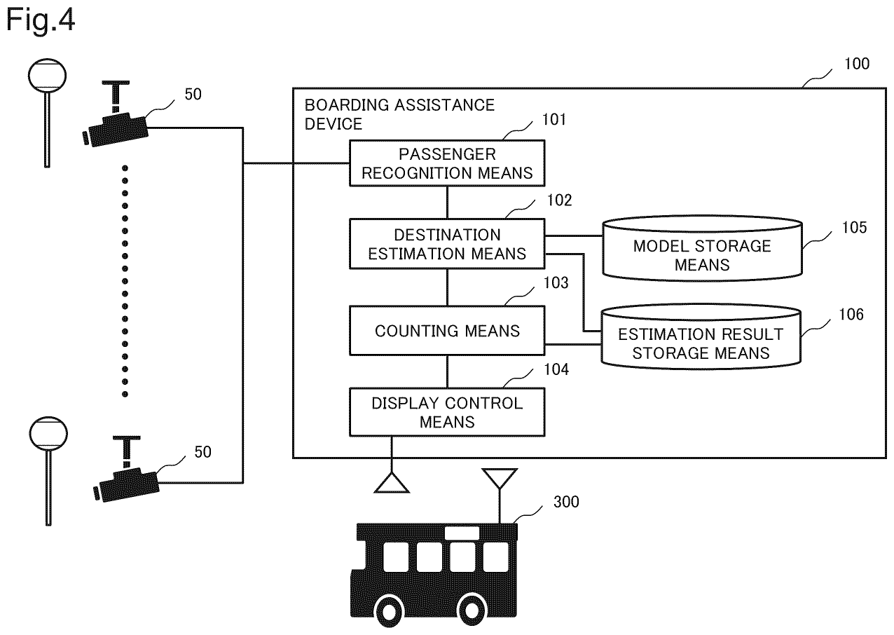

Next, a first example embodiment of the present invention in which a destination of a passenger is estimated using an image recognition technology will be described in detail with reference to the drawings. FIG. 4 is a diagram illustrating a configuration according to the first example embodiment of the present invention. Referring to FIG. 4, a configuration including one or more cameras 50, a boarding assistance device 100 capable of acquiring images from the cameras, and a vehicle 300 including a destination display device that is display-controlled by the boarding assistance device 100 is illustrated.

The camera 50 is a camera installed in such a way as to be capable of imaging a passenger waiting to board in a boarding area (a bus stop in the example of FIG. 4) for public transport. The camera 50 may be a camera dedicated to the boarding assistance device 100, or may be a camera installed for the purpose of crime prevention or improvement of a customer service.

The boarding assistance device 100 includes passenger recognition means 101, destination estimation means 102, counting means 103, display control means 104, model storage means 105, and estimation result storage means 106.

The model storage means 105 stores a classification model for estimating a destination of the passenger imaged by the camera 50. Very simply, the model storage means 105 stores a classification model for identifying the destination based on a gender, an age group, clothes, belongings, and the like of a person imaged by the camera 50. Such a classification model can be created by various types of machine learning using training data in which an image of a person actually imaged by the camera 50 is associated with an actual destination (ground truth data) of the person.

When the passenger recognition means 101 recognizes the passenger waiting to board in the boarding area (the bus stop in the example of FIG. 4) for the public transport, the passenger recognition means 101 transmits the image of the passenger to the destination estimation means 102 to request estimation of the destination.

Upon receiving the image of the passenger from the passenger recognition means 101, the destination estimation means 102 estimates the destination of the passenger by using the classification model for destination estimation held in the model storage means 105. Further, the destination estimation means 102 sets a passenger ID for the passenger whose destination is estimated, and stores the passenger ID in the estimation result storage means 106.

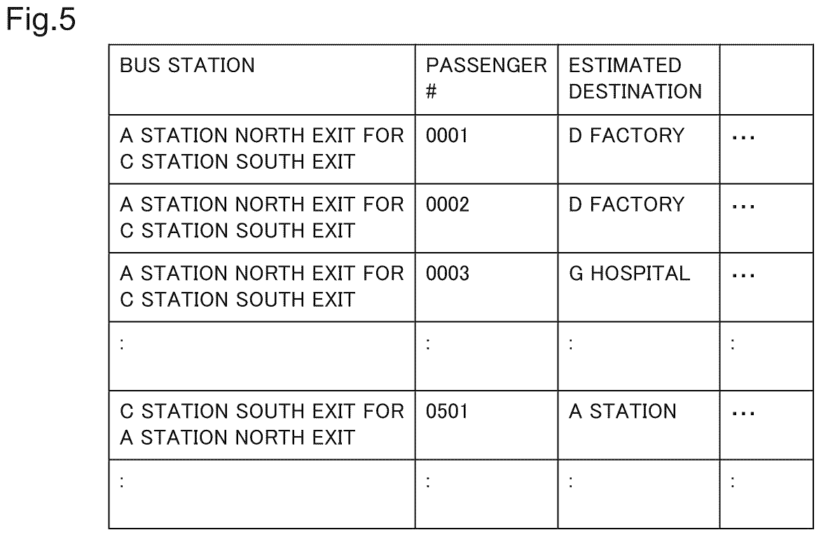

FIG. 5 is a diagram illustrating an example of estimation result information held in the estimation result storage means 106. In the example of FIG. 5, three passengers are recognized at a bus stop “A station north exit”, and estimated destinations of the three passengers are recorded.

The counting means 103 counts the number of passengers for each estimated destination by referring to the estimation result storage means 106. For example, the counting means 103 counts the number of passengers heading from the bus stop “A station north exit” to a D factory as two and counts the number of passengers heading to a G hospital as one from the estimation result information.

The display control means 104 creates a content to be displayed on the destination display device of the vehicle 300 of the public transport based on the result counted by the counting means 103, and transmits the content to the vehicle 300. The content transmitted from the display control means 104 to the vehicle 300 may be a content itself to be displayed on the destination display device, or may be control information including characters or numerical values including the count value counted by the counting means 103. In a case where the boarding assistance device 100 transmits the control information including the characters or numerical values, a display content is created based on the control information received by the vehicle.

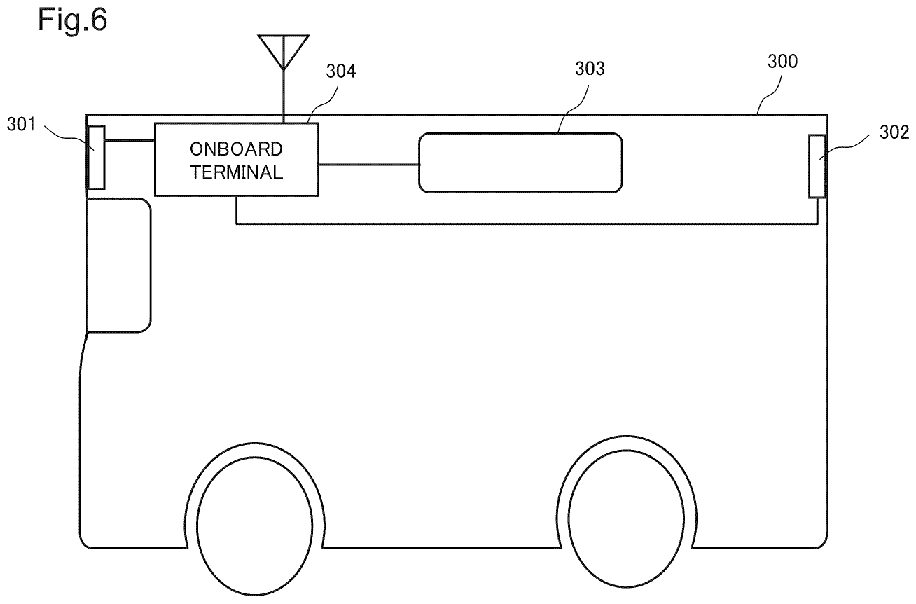

FIG. 6 is a diagram illustrating a configuration of the vehicle 300 in which the boarding assistance device 100 of the present example embodiment performs display control. Referring to FIG. 6, the vehicle 300 includes a destination display device 301 set on a front surface of the vehicle, a destination display device 302 set on a rear surface of the vehicle, a destination display device 303 set on a side surface of the vehicle, and an onboard terminal 304. Each of the destination display devices 301 to 303 is implemented by a display device that can display various characters and figures, which is also referred to as a destination sign.

The onboard terminal 304 performs display on the destination display devices 301 to 303 based on destination display instruction information received from the boarding assistance device 100. As a communication form between the onboard terminal 304 and the boarding assistance device 100, various methods such as a form using a mobile communication network and a form using a roadside unit or the like installed in the vicinity of a road can be used.

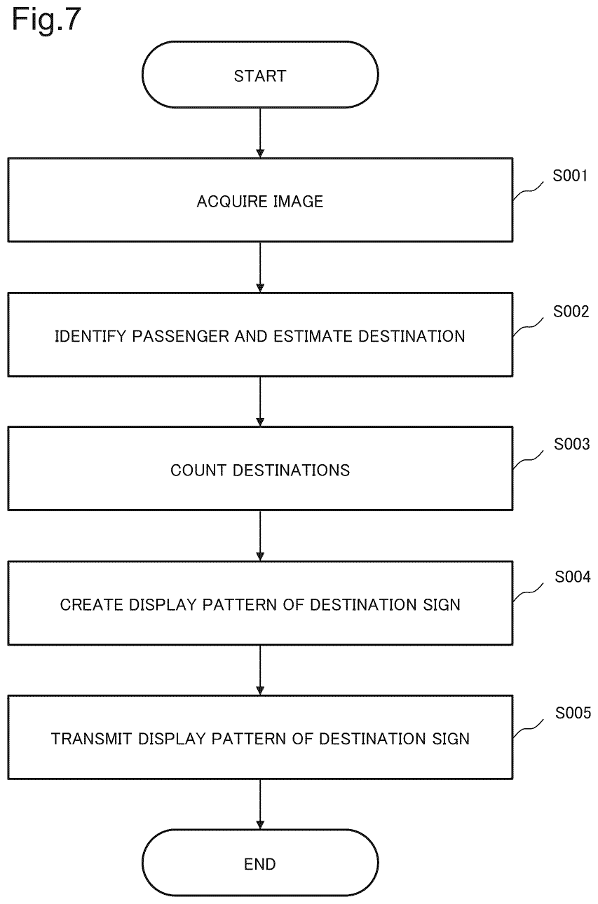

Next, a boarding assistance method used in the boarding assistance device 100 of the present example embodiment will be described in detail with reference to the drawings. FIG. 7 is a flowchart illustrating an operation of the boarding assistance device 100 of the first example embodiment of the present invention. Referring to FIG. 7, first, the boarding assistance device 100 acquires the image from the camera 50 installed in such a way as to be able to image the passenger waiting to board in the boarding area for the public transport (step S001).

Next, the boarding assistance device 100 identifies the passenger in the image and estimates the destination of the passenger (step S002). For example, the boarding assistance device 100 estimates the destination of the passenger by setting a bounding box in a portion where the passenger is shown in the image and inputting the setting to the classification model.

Next, the boarding assistance device 100 counts the destinations for each boarding area for the public transport (step S003). Next, the boarding assistance device 100 creates a display content (a display pattern of the destination sign) in such a way that the more the passengers heading to a destination, the longer the display time for the destination based on the counting result (step S004).

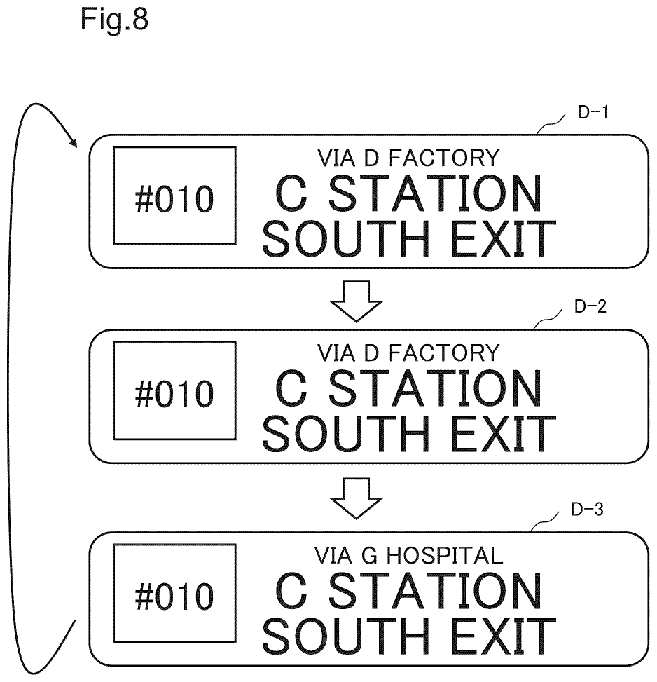

FIG. 8 is a diagram illustrating an example of the display pattern of the destination sign displayed on the destination display devices 301 to 303 in a case where the counted number of passengers heading from the bus stop “A station north exit” to the D factory is two, and the counted number of passengers heading to the G hospital is one. In the example of FIG. 8, since there are three passengers, three display screens are created, two of the display screens are assigned to “C station south exit via D factory”, and the remaining one is assigned to “C station south exit via G hospital”.

Next, the boarding assistance device 100 transmits the created display pattern of the destination sign to the vehicle 300 (step S005).

The onboard terminal 304 of the vehicle 300 that has received the display pattern of the destination sign causes the destination display devices 301 to 303 to perform display according to the received display pattern of the destination sign.

The passengers identified by passenger IDs #0001 to #0003 and viewing the destination sign changing as described above confirm the destinations with the display contents of the destination display devices 301 to 303 and then board the vehicle 300. At this time, the passengers identified by the passenger IDs #0001 to #0003 can confirm that the vehicle 300 passes through their destinations, and thus, the passengers can confidently board the vehicle 300.

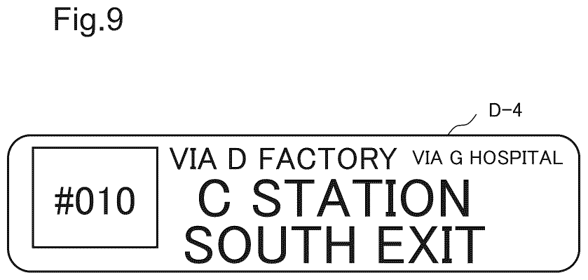

In the above example, an example in which the boarding assistance device 100 displays a stopping point in such a way that the display time becomes longer according to the number of passengers for each destination has been described, but display modes on the destination display devices 301 to 303 are not limited thereto. For example, it is also possible to display the stopping point in such a way that a display region or a font is increased in size according to the number of passengers for each destination. For example, the example of FIG. 9 illustrates an example of the destination sign in which the characters “via D factory” for two passengers are increased in size and the characters “via G hospital” is reduced in size. By adopting such a display pattern, for example, it is possible to further prevent the passenger going to the G hospital from overlooking the display of “C station south exit via G hospital” in comparison with the display pattern of FIG. 8.

In the above example, a description has been given assuming that the boarding assistance device 100 identifies the passenger from the image captured by the camera 50 and estimates the destination, but a method of identifying the passenger and estimating the destination is not limited thereto. The passenger may hold a portable terminal (a smartphone in which each function is implemented by an application program) having a map display function and a route search function. Some of the map display function and the route search function may automatically acquire the current location of the user. In this case, the boarding assistance device 100 can acquire position information of the portable terminal by communicating with the portable terminal or a server that provides a service to the portable terminal. Then, the boarding assistance device 100 may recognize the passenger waiting to board in the boarding area for the public transport by using the acquired position information.

Furthermore, the boarding assistance device 100 can communicate with the portable terminal or the server that provides a service to the portable terminals, and can acquire a destination input to the map display function or the route search function and an output result of the functions. The boarding assistance device 100 can also estimate the destination of the passenger by using the acquired information. In addition, the boarding assistance device 100 can provide the acquired information regarding the destination or the like to the destination estimation means 102 and use the information as auxiliary information for narrowing down the destination to be estimated.

### Second Example Embodiment

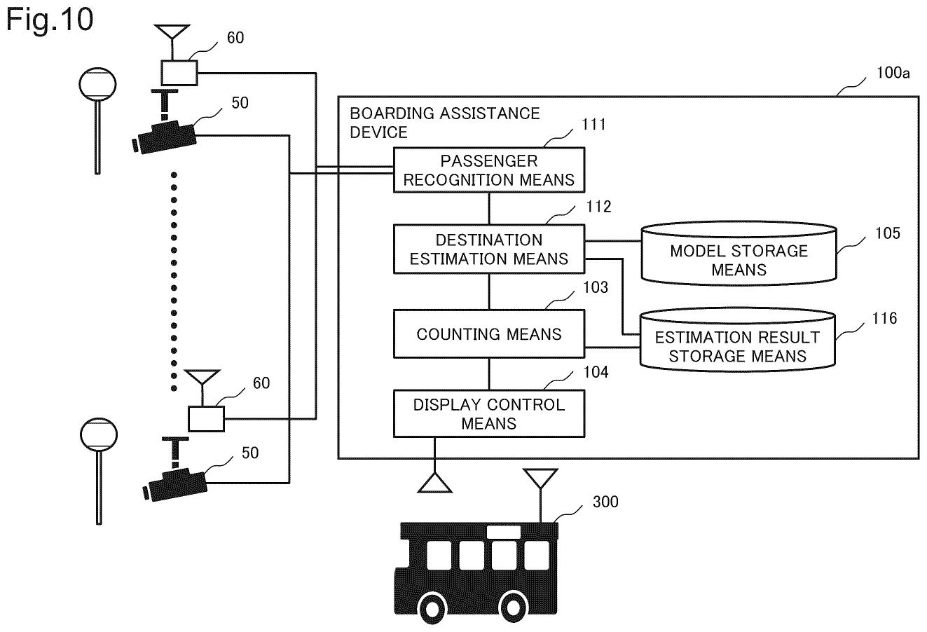

Next, a second example embodiment of the present invention in which a boarding assistance device 100a estimates a destination by using information of an IC card carried by a passenger in addition to a camera image will be described in detail with reference to the drawings. FIG. 10 is a diagram illustrating a configuration of the boarding assistance device 100a of the second example embodiment of the present invention. The first difference from the first example embodiment illustrated in FIG. 4 is that an IC card reader 60 is installed in addition to a camera 50 in a boarding area for public transport. The second difference from the first example embodiment is operations of passenger recognition means 111 and destination estimation means 112. Furthermore, the third difference from the first example embodiment is that estimation result storage means 116 can hold IC card information. Since the other configurations are similar to those of the first example embodiment, differences will be mainly described below.

The IC card reader 60 includes short-distance wireless communication means capable of reading the IC card or the like serving as a ticket. As such an IC card reader 60, a device called a smart bus stop terminal or the like can also be used in addition to a dedicated device. When the passenger brings the IC card close, the IC card reader 60 reads a content of the IC card and transmits the read content to the boarding assistance device 100a. Further, the IC card reader 60 may have a transfer route search function or a fare calculation function for a passenger heading to a destination. In this case, since the IC card reader 60 can obtain destination candidates of the passenger, the IC card reader 60 may transmit information regarding a destination inquired by the passenger to the boarding assistance device 100a in addition to the information of the IC card.

The passenger recognition means 111 of the boarding assistance device 100a transmits the information obtained from the IC card reader 60 to the destination estimation means 112.

The destination estimation means 112 estimates the destination by using the IC card information in addition to the camera image. More specifically, the destination estimation means 112 selects, by using the IC card information, a destination having a higher likelihood among destinations estimated by using a classification model. For example, in a case where the recognized passenger has a commuter pass, the destination estimation means 112 selects a destination in a range of a commuter pass use section. In addition, in a case where the information regarding the destination inquired by the passenger is obtained, the destination estimation means 112 may select the destination by comparing the destination estimated using the classification model with the destination.

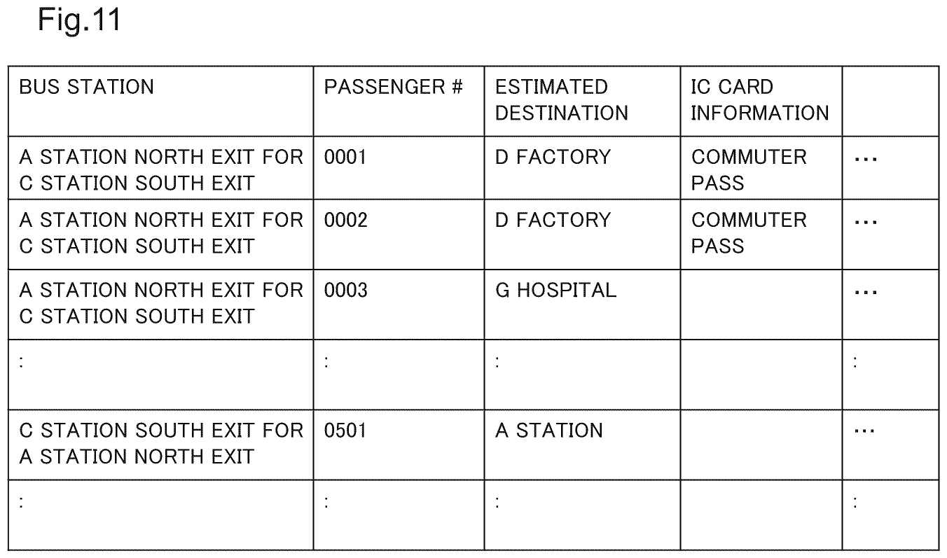

FIG. 11 is a diagram illustrating an example of estimation result information held in the estimation result storage means 116 of the present example embodiment. In the example of FIG. 11, an “IC card information” field is added in addition to the estimation result information of FIG. 5.

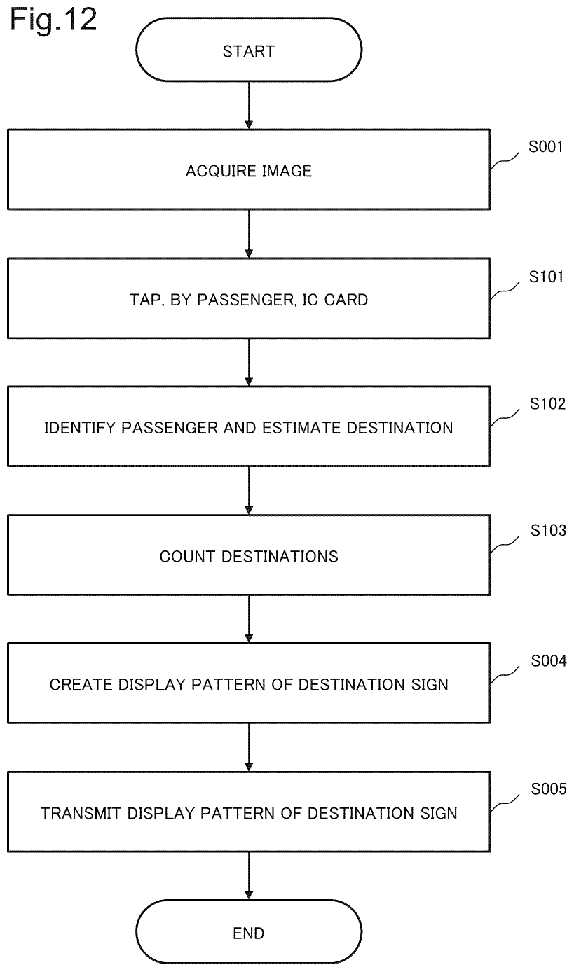

Next, an operation according to the present example embodiment will be described in detail with reference to the drawings. FIG. 12 is a flowchart illustrating an operation of the boarding assistance device 100a of the second example embodiment of the present invention. A difference from the operation of the boarding assistance device 100 of the first example embodiment illustrated in FIG. 7 is that processing of reading, by the IC card reader 60, the information of the IC card tapped by the passenger and transmitting the information to the boarding assistance device 100a (step S101) is added.

Thereafter, the boarding assistance device 100a uses both the image and the IC card information to identify the passenger and estimate the destination of the passenger (step S102).

Next, the boarding assistance device 100a counts the destinations for each boarding area for the public transport (step S103). At this time, the boarding assistance device 100a performs counting excluding passengers (passengers #0001 and #0002 in FIG. 11) who board with the commuter pass.

Then, the boarding assistance device 100a creates a display content (a display pattern of a destination sign) in such a way that a display time for a destination with more passengers becomes longer based on the counting result (step S004). For example, in a case where the estimation result information as illustrated in FIG. 11 is obtained, since the counting is performed by excluding passengers who board with the commuter pass (passengers #0001 and #0002 in FIG. 11), only one passenger heading from a bus stop “A station north exit” to a G hospital is counted.

FIG. 12 is a diagram illustrating an example of the display pattern of the destination sign displayed on destination display devices 301 to 303 in a case where the counted number of passengers heading from the bus stop “A station north exit” to the G hospital is one. In the example of FIG. 12, since there is one passenger, a display screen displaying “C station south exit via G hospital” is created.

According to the operation of the present example embodiment as described above, the counting is performed by excluding a passenger who frequently boards the public transport in the boarding area based on the recognition result of the passenger recognition means 111, and the content to be displayed on the destination display device is created. Therefore, it is possible to create a display content for a passenger who is truly unfamiliar with the area.

In the above example embodiment, it has been described that the IC card reader 60 reads the IC card serving as the ticket, but the IC card reader 60 may read information equivalent to the IC card from a portable terminal such as a smartphone with an IC card function.

In the above example embodiment, the IC card reader 60 is used. However, various devices that can acquire information that enables estimation of a boarding frequency and a destination of a passenger from various portable terminals possessed by the passenger can also be used. For example, the boarding assistance device 100a can also grasp the boarding frequency of the passenger when a base station device or the like that receives an ID or the like of a passenger from a smartphone or a smart watch carried by the passenger and holds the ID or the like for a certain period provides the ID of the passenger to the boarding assistance device 100a.

While the invention has been particularly shown and described with reference to example embodiments thereof, the invention is not limited to these example embodiments, and further modifications, substitutions, and adjustments may be made without departing from the basic technical idea of the present invention. For example, the network configuration, the configuration of each element, and the expression form of data illustrated in the drawings are examples for assisting the understanding of the present invention, and the present invention is not limited to the configurations illustrated in the drawings.

For example, in the above example embodiments, an example in which the present invention is applied to a public bus has been described as an example of the public transport, but the present invention can also be applied to other than a public bus. For example, for trams, trains, ferries, and the like, similarly, it is possible to estimate a destination of a passenger waiting to board in a boarding area, and display the estimated destination on a destination display device based on a counting result.

In the above example embodiments, the destination display device is described as the destination display device installed on the vehicle body of the bus, but the destination display device does not have to necessarily be installed on the vehicle body. For example, the present invention can also be applied to a destination display in a display device for passenger guidance installed in a boarding area.

### (Hardware Configuration)

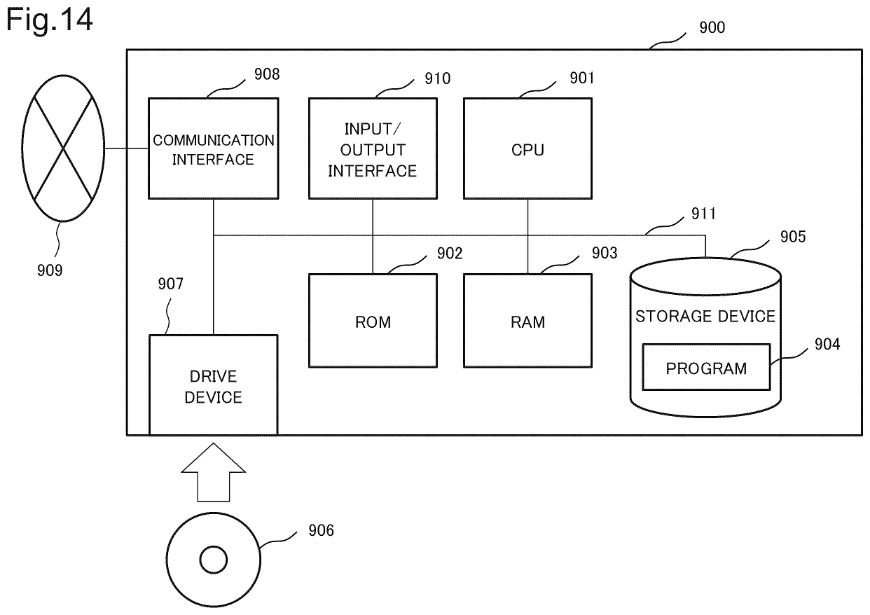

In each example embodiment of the present disclosure, the components of each device indicate functional unit blocks. Some or all of the components of each device are implemented by, for example, any combination of the information processing device 900 and a program as illustrated in FIG. 14. FIG. 14 is a block diagram illustrating an example of a hardware configuration of the information processing device 900 that implements the components of each device. The information processing device 900 has the following configuration by way of example.
A central processing unit (CPU) 901
A read only memory (ROM) 902
A random access memory (RAM) 903
A program 904 loaded to the RAM 903.
A storage device 905 storing the program 904
A drive device 907 that performs reading and writing on a program recording medium 906
A communication interface 908 connected to a communication network 909
An input/output interface 910 for inputting/outputting data.
A bus 911 connecting the components

Each component of each device in each example embodiment is implemented by the CPU 901 acquiring and executing the program 904 for implementing these functions. That is, it is sufficient if the CPU 901 of FIG. 14 executes a destination counting program and a display control program to perform update processing for each calculation parameter held in the RAM 903, the storage device 905, or the like. The program 904 for implementing the function of each component of each device is stored in advance in a program recording medium such as the storage device 905 or the ROM 902, and is read by the CPU 901 as necessary. The program 904 may be supplied to the CPU 901 via the communication network 909, or may be stored in advance in the program recording medium 906, and the drive device 907 may read the program and supply the program to the CPU 901.

In addition, the program 904 can display a processing result including an intermediate state for each stage via the display device as necessary, or can communicate with the outside via the communication interface. In addition, the program 904 can be recorded in a computer-readable (non-transitory) program recording medium.

There are various modified examples of the method of implementing each device. For example, each device may be implemented by any combination of the information processing device 900 and the program for each component. A plurality of components included in each device may be implemented by any combination of one information processing device 900 and the program. That is, the communication terminal and network control device described in the first to third example embodiments described above can be implemented by a computer program that causes a processor mounted in each of the devices to perform each of the above-described processings by using the hardware.

In addition, some or all of the components of each device are implemented by another general-purpose or dedicated circuitry, processor, or the like, or a combination thereof. These may be implemented by a single chip or may be implemented by a plurality of chips connected via a bus.

Some or all of the components of each device may be implemented by a combination of the above-described circuitry or the like and the program.

In a case where some or all of the components of each device are implemented by a plurality of information processing devices, circuitries, and the like, the plurality of information processing devices, circuitries, and the like may be arranged in a centralized manner or in a distributed manner. For example, the information processing device, the circuitry, and the like may be implemented as a form in which each is connected via a communication network, such as a client and server system or a cloud computing system.

Each of the above-described example embodiments is a preferred example embodiment of the present disclosure, and the scope of the present disclosure is not limited only to each of the above-described example embodiments. That is, it is possible for those skilled in the art to make modifications and substitutions of the above-described example embodiments without departing from the gist of the present disclosure, and to construct a mode in which various modifications are made.

Some or all of the above-described example embodiments can also be described as the following Supplementary Notes, but are not limited thereto.

### Supplementary Note 1

A boarding assistance device including:
passenger recognition means for recognizing a passenger waiting to board in a boarding area for public transport;
destination estimation means for estimating a destination of the passenger;
counting means for counting a number of passengers for each destination; and
display control means for causing a predetermined destination display device to perform destination display according to the number of passengers for each destination.

### Supplementary Note 2

The destination estimation means of the boarding assistance device can estimate the destination of the passenger based on an image of the passenger captured by a camera.

### Supplementary Note 3

The display control means of the boarding assistance device can perform the destination display in such a way that the more the passengers heading to the destination, the longer the display time for the destination or the larger the display region for the destination.

### Supplementary Note 4

The boarding assistance device can use a destination sign mounted on a vehicle of the public transport as the destination display device.

### Supplementary Note 5

The destination estimation means of the boarding assistance device can estimate the destination of the passenger based on information acquired from a terminal carried by the passenger.

### Supplementary Note 6

The counting means of the boarding assistance device can count the number of passengers for each of the destinations by excluding a passenger who frequently boards the public transport in the boarding area, based on a recognition result of the passenger recognition means.

### Supplementary Note 7

An onboard terminal having a function of receiving a destination display instruction from the boarding assistance device described above and displaying the destination on a display device set on a front surface, a rear surface, or a side surface of a vehicle.

### Supplementary Note 8

A boarding assistance method including:
recognizing a passenger waiting to board in a boarding area for public transport;
estimating a destination of the passenger;
counting a number of passengers for each destination; and
causing a predetermined destination display device to perform destination display according to the number of passengers for each destination.

### Supplementary Note 9

A program recording medium recording a program for causing a computer to execute processing of:
recognizing a passenger waiting to board in a boarding area for public transport;
estimating a destination of the passenger;
counting a number of passengers for each destination; and
causing a predetermined destination display device to perform destination display according to the number of passengers for each destination.

The modes of Supplementary Notes 8 and 9 can be extended in the modes of Supplementary Notes 2 to 6 like Supplementary Note 1.

The disclosures of the above-described patent literatures are incorporated herein by reference, and can be used as a basis or part of the present invention as necessary. Within the range of the entire disclosure (including the claims) of the present invention, it is possible to change and adjust the example embodiments or examples further based on the basic technical idea thereof. In addition, various combinations or selections (including partial deletions) of various disclosed elements (including the elements of the claims, the elements of the example embodiments or examples, the elements of the drawings, and the like) can be made within the range of the disclosure of the present invention. That is, it is a matter of course that the present invention includes various modifications and corrections that can be made by those skilled in the art in accordance with the entire disclosure including the claims and the technical idea. In particular, for numerical ranges set forth herein, any numerical value or sub-range included within the range should be construed as being specifically described, even if not stated otherwise. In addition, as needed and based on the gist of the present invention, partial or entire use of the disclosed matters in the above cited literatures in combination with the matters disclosed in the present application should be deemed to be included in the matters disclosed in the present application, as a part of the disclosure of the present invention.

### REFERENCE SIGNS LIST

10, 100, 100a boarding assistance device
11, 101, 111 passenger recognition means
12, 102, 112 destination estimation means
13, 103 counting means
14, 104 display control means
50 camera
105 model storage means
106, 116 estimation result storage means
300 vehicle
301 to 303 destination display device
304 onboard terminal
900 information processing device
901 central processing unit (CPU)
902 read only memory (ROM)
903 random access memory (RAM)
904 program
905 storage device
906 program recording medium
907 drive device
908 communication interface
909 communication network
910 input/output interface
911 bus

What is claimed is:

1. A boarding assistance device comprising:
one or more memories storing instructions; and
one or more processors configured to execute the instructions to:
recognize a passenger waiting to board in a boarding area for public transport;
estimate a destination of the passenger;
count a number of passengers for each destination; and
cause a predetermined destination display device to perform destination display according to the number of passengers for each destination.

2. The boarding assistance device according to claim 1, wherein the one or more processors configured to execute the instructions to:
estimate the destination of the passenger based on an image of the passenger captured by a camera.

3. The boarding assistance device according to claim 1, wherein the one or more processors configured to execute the instructions to:
perform the destination display configured in such a way that the more the passengers heading to the destination, the longer the display time for the destination or the larger the display region for the destination.

4. The boarding assistance device according to claim 1, wherein a destination sign mounted on a vehicle of the public transport is used as the destination display device.

5. The boarding assistance device according to claim 1, wherein the one or more processors configured to execute the instructions to:
estimate the destination of the passenger based on information acquired from a terminal carried by the passenger.

6. The boarding assistance device according to claim 1, wherein the one or more processors configured to execute the instructions to:
count the number of passengers for each of the destinations by excluding a passenger who frequently boards the public transport in the boarding area, based on a recognition result of the passenger.

7. (canceled)

8. A boarding assistance method comprising:
recognizing a passenger waiting to board in a boarding area for public transport;
estimating a destination of the passenger;
counting a number of passengers for each destination; and
causing a predetermined destination display device to perform destination display according to the number of passengers for each destination.

9. A program recording medium recording a program for causing a computer to execute processing of:
recognizing a passenger waiting to board in a boarding area for public transport;
estimating a destination of the passenger;
counting a number of passengers for each destination; and
causing a predetermined destination display device to perform destination display according to the number of passengers for each destination.
